(19) United States
(12) Patent Application Publication
(10) Pub. No.: US 2010/0282035 A1
(43) Pub. Date: Nov. 11, 2010

(54) Tool handle with replaceable tool head

(76) Inventor: Yao Hong Wang, Taichung County (TW)

Correspondence Address: Yao Hong Wang, P.O. Box 44-2049, Taipei, 10668, TW

(21) Appl. No.: 12/453,278

(22) Filed: May 6, 2009

(51) Int. Cl. B25G 1/00

(52) U.S. Cl. 81/489

(57) ABSTRACT

The present invention provides a tool handle mechanism with replaceable tool head, wherein at least a clip is arranged in the slot of the tool handle for mating with the tool head; it structurally comprises a tool handle and several replaceable tool heads, of which a slot is grooved into one end of the tool handle, and a clip arranged on the slot wall; one end of the clip is designed into a protruding spring portion, so that when the inserting portion of the tool head is inserted into the slot of the tool handle, the tool head can be replaced rapidly and also mated tightly with the tool handle with the support of the spring portion.

### BACKGROUND OF INVENTION

(1) Field of the Invention

The present invention relates generally to a tool handle mechanism with replaceable tool head, and more particularly to an innovative one which is designed to assemble or replace the tool head in a robust manner.

(2) Description of the Prior Art

A tool handle mechanism with replaceable tool head has been developed in response to cost-effectiveness and ease-of-operation for the users. It is structurally designed in a manner that a slot is preset onto one end of the tool handle, wherein a joint corresponding to the tool head can be inserted; and, a steel ball is placed on the slot wall or tool joint to ensure that the tool head and tool handle are coupled fixedly.

However, the traditional tool handle has the following structural shortcomings:

Firstly: if the steel ball is embedded fixedly into the slot wall or joint to strengthen the coupling of the tool joint and slot, great efforts must be required to link or separate them, leading to inconvenience in operation.

Secondly, if the steel ball is installed or arranged flexibly, a spring must be additionally assembled within the steel ball, thus increasing greatly the processing cost and fabrication difficulty.

Thirdly, wear and tear of steel ball may occur due to long-lasting linkage or separation of the tool joint and slot, resulting in loss of original stress and inconvenience against applicability and cost-effectiveness.

### SUMMARY OF THE INVENTION

In view of the existing shortcomings of typical replaceable tool handle, the inventor has modified and developed the tool handle mechanism with replaceable tool head (shown in FIG. 2) for stronger operational efficacy.

A tool handle mechanism with replaceable tool head, which comprising:

a tool handle, where a slot is groove into either the front or rear end, and at least a clip is arranged within the slot;

a tool head, at one end of which an inserting portion is placed correspondingly to the slot of the tool handle;

a striplike clip, one end of which is fixed onto the locating end of the slot wall, and the other end designed into a protruding spring portion;

with the support of the spring portion of clip, the inserting portion of the tool head can be securely inserted into the slot of the tool handle, so that the tool head can be replaced rapidly and also mated tightly with the tool handle.

The second objective and efficacy of the present invention lie in that, the clip is fastened onto the slot wall by means of riveting, welding or screwing, making it possible for easier processing and significant reduction of manufacturing error, thus avoiding any extra loss of cost.

The third objective and efficacy of the present invention lie in that, the spring portion of the clip is extensively abutted onto the tool head, so as to ensure the linking stability of the slot and inserting portion of the tool head.

The fourth objective and efficacy of the present invention lie in that, the mating tightness with the tool head can be maintained through the compaction tolerance of the clip's spring portion, preventing the structural abrasion of tools and loss of original functions due to long-lasting insertion or removal of the tool head.

### BRIEF DESCRIPTION OF THE DRAWINGS

FIG. 1 shows a perspective view of the preferred embodiment of the present invention.

FIG. 2 shows an exploded view of the components of the preferred embodiment of the present invention.

FIG. 3 shows an exploded view of the tool head and tool handle of the preferred embodiment of the present invention.

FIG. 4 shows a top sectional view of tool handle B_B of the preferred embodiment of the present invention.

FIG. 5 shows a lateral sectional view of tool handle A_A of the preferred embodiment of the present invention.

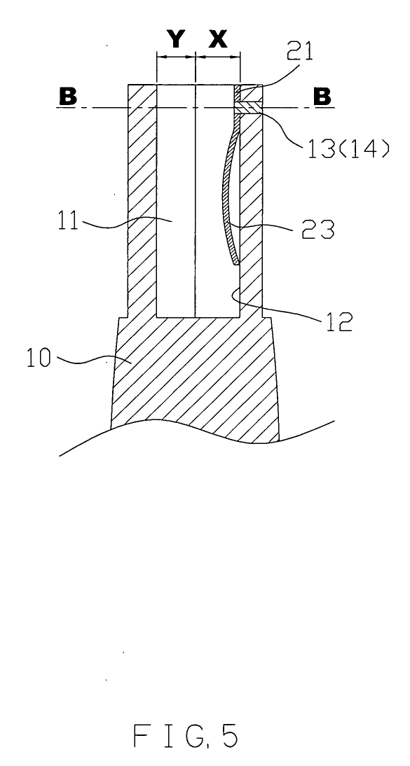

FIG. 6 shows a lateral sectional view of the tool head and tool handle of the preferred embodiment of the present invention.

FIG. 7 shows a top sectional view of tool handle D_D (with slot) of the preferred embodiment of the present invention.

FIG. 8 shows a lateral sectional view of tool handle C_C (with slot) of the preferred embodiment of the present invention.

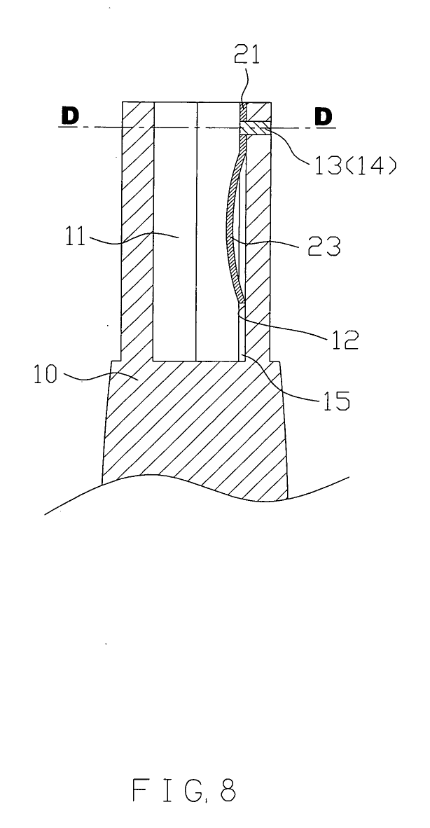

FIG. 9 shows a preferred embodiment 1 of the present invention.

FIG. 10 shows another preferred embodiment 2 of the present invention.

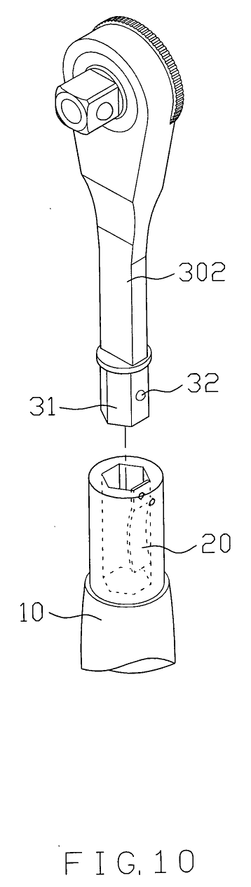

FIG. 11 shows another preferred embodiment 3 of the present invention.

FIG. 12 shows a top view 1 of a preferred embodiment of the present invention showing the profile change of slot.

FIG. 13 shows a top view 2 of another preferred embodiment of the present invention showing the profile change of slot.

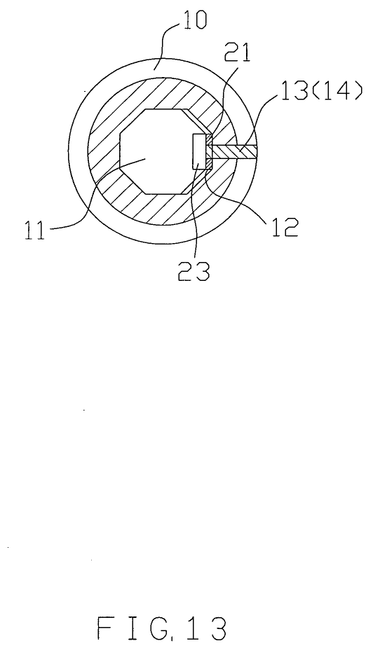

FIG. 14 shows a sectional view 1 of a preferred embodiment of the present invention showing the fixation of clip.

FIG. 15 shows a sectional view 2 of another preferred embodiment of the present invention showing the fixation of clip.

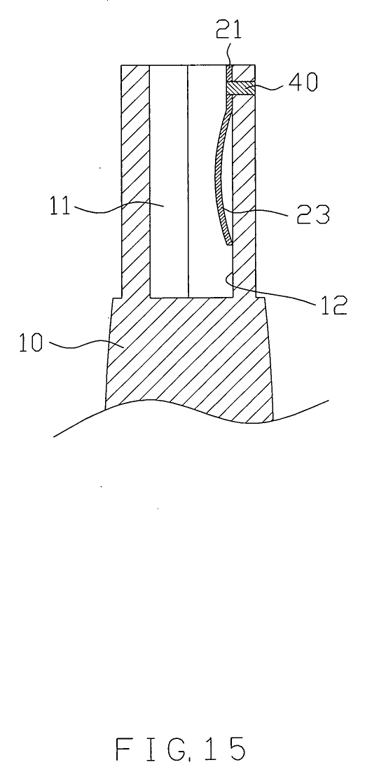

### DETAILED DESCRIPTION OF THE PREFERRED EMBODIMENTS

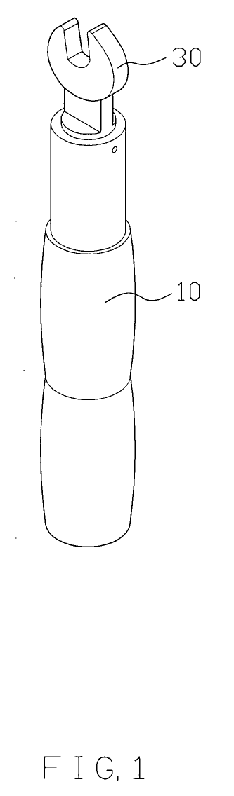

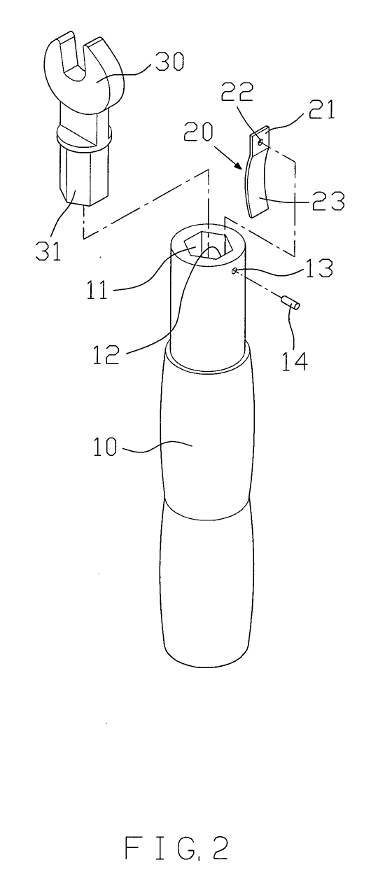

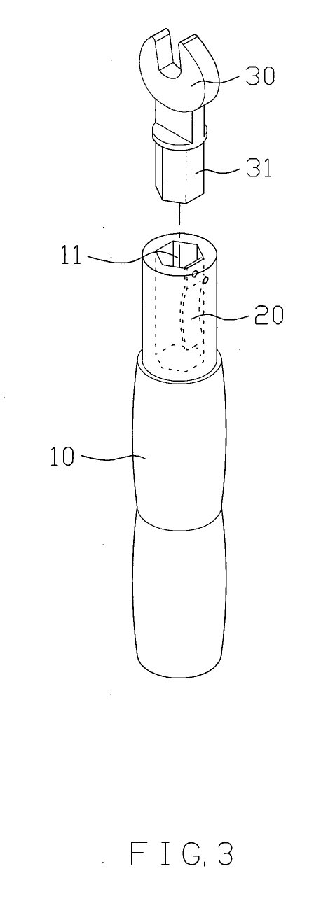

Referring to FIGS. 1-3, the preferred embodiment of the present invention is structurally designed that a slot 11 is grooved into one end of the tool handle 10, and a locating hole 13 is penetrated from the exterior of the tool handle 10 to the slot 11; a clip 20 is arranged on the locating wall 12 of the slot 11, with one end fixed onto the locating end 21 of the locating wall 12, and the other end designed into a protruding spring portion 23; the locating end 21 is designed with a through-hole 22 corresponding to the locating hole 13; moreover, one end of the tool head 30 is provided protrudely with an inserting portion 31 for the slot 11 of the tool handle 10.

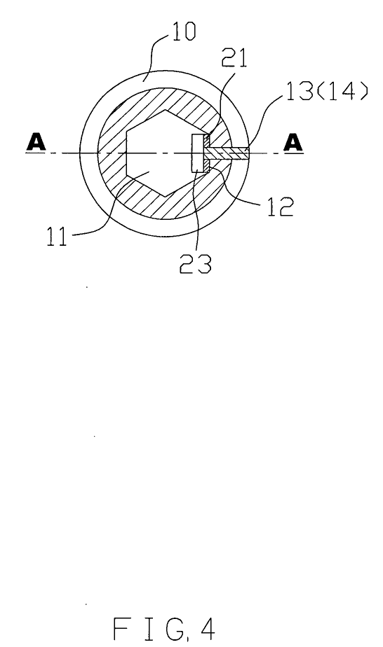

Referring to FIGS. 4˜5, the striplike clip 20 is riveted into the locating hole 13 and through-hole 22 via a fixture 14, so that the clip 20 is fixed onto the locating wall 12 of the slot 11; the distance X from the locating wall 12 to the central axial line of the slot 11 is longer than the distance Y from other inner walls of the slot 11 to the central axial line, so the slot 11 is designed into a non-equilateral hexagon for accommodating the clip 20; the locating end 21 of the clip 20 is less wide than the locating wall 12.

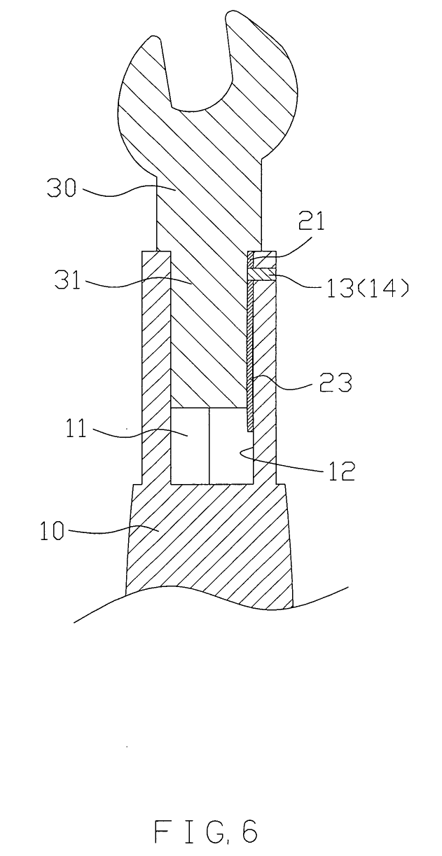

Referring to FIG. 1 and FIG. 6, when the tool head 30 is mated with the tool handle 10, the inserting portion 31 is inserted securely into the slot 11, so the spring portion 23 of the clip 20 is squeezed towards the locating wall 12 and the exterior of the inserting portion 31 is compressed tightly, realizing excellent positioning of the tool head 30.

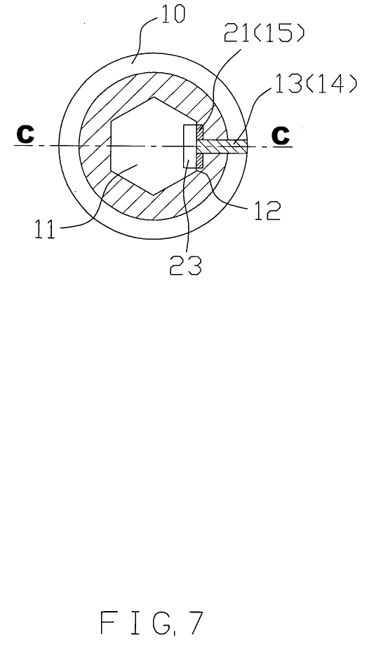

Referring to FIGS. 7˜8, if the slot 11 is designed into an equilateral hexagon, an axial groove 15 shall be opened on the slot 11 for accommodating the locating end 21 of the clip 20; alternatively, when the inserting portion 31 is inserted into the slot 11, the spring portion 23 of the clip 20 is provided with an inward squeezing tolerance, thus improving the smoothness of inserting or removing the tool head 30.

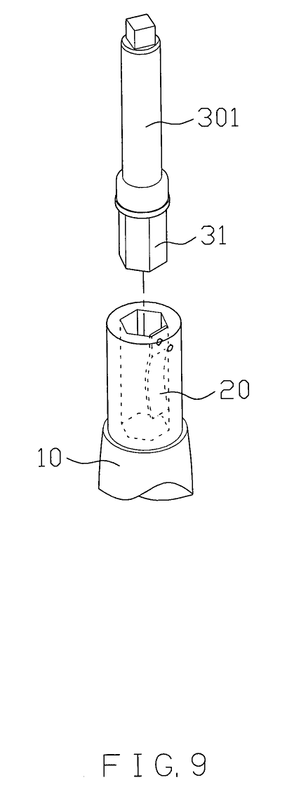

Referring to FIGS. 9˜10, the tool heads 301, 302 are designed into a four-pin column or ratchet spanner in tune with the plug-in sleeve, while the inserting portion 31 is arranged on the other end correspondingly to the slot 11 of the tool handle 10; furthermore, a steel ball 32 is embedded externally onto the inserting portion 31, helping to realize double locking along with the assembled clip 20.

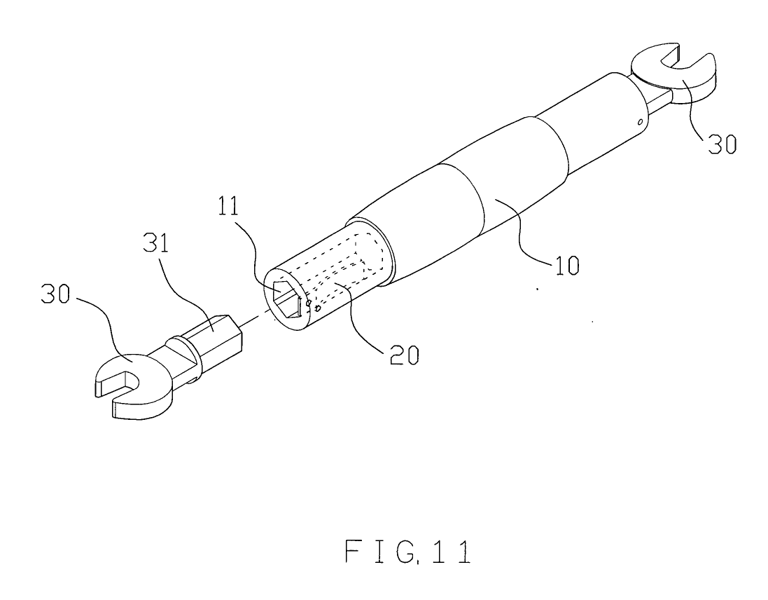

Referring also to FIG. 11, a slot 11 is groove into either the front or rear end of the tool handle 10, and a clip 20 is arranged within the slot for sleeving of the tool head 30 conveniently.

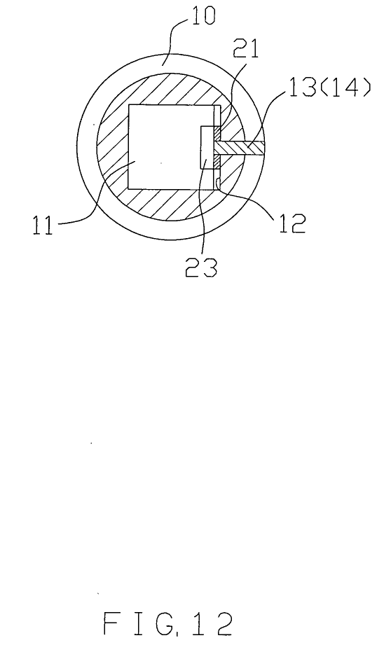

Referring also to FIGS. 12˜13, the slot 11 and inserting portion 31 can be assembled into different profiles, e.g. quadrangle or polygon.

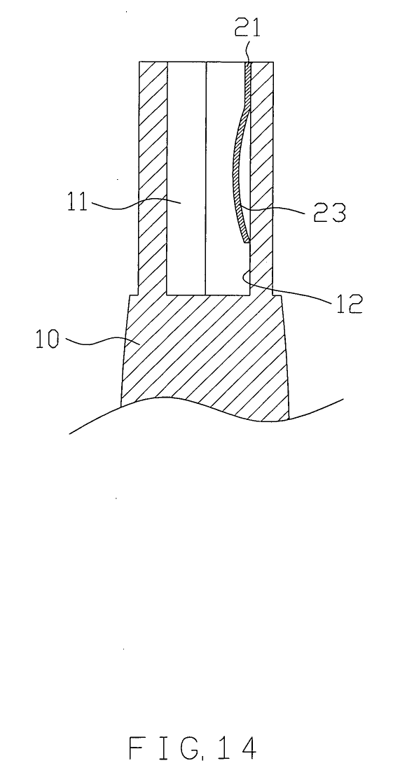

Referring also to FIGS. 14˜15, the clip 20 can also be fixed into the slot 11 by welding of the locating end 21 onto the locating wall 12, or by fixing it via a bolt 40 from exterior of the tool handle 10.

Although the invention has been explained in relation to its preferred embodiment, it is to be understood that many other possible modifications and variations can be made without departing from the spirit and scope of the invention as hereinafter claimed.

What is claimed is:

1. A tool handle mechanism with replaceable tool head, which comprising:
a tool handle, where a slot is grooved into either the front or rear end, and at least a clip is arranged within the slot;
a tool head, at one end of which an inserting portion is placed correspondingly to the slot of the tool handle;
a striplike clip, one end of which is fixed onto the locating end of the slot, and the other end designed into a protruding spring portion;
with the support of the spring portion of clip, the tool head can be inserted into the slot of the tool handle, so that when the inserting portion of the tool head is inserted into the slot of the tool handle, the spring portion can be abutted tightly on the exterior of the inserting portion, making the secure mating of the tool head and the tool handle.

2. The structure defined in claim 1, wherein a locating hole is penetrated from the exterior of the tool handle to the slot; the locating end of the clip is designed with a through-hole corresponding to the locating hole; the clip is riveted into the locating hole and through-hole via a fixture, so that the locating end of the clip is fixed onto the locating wall.

3. The structure defined in claim 1, wherein the locating end of the clip is bolted onto the locating wall.

4. The structure defined in claim 1, wherein the locating end of the clip is welded onto the locating wall.

5. The structure defined in claim 1, wherein the distance from the locating wall to the central axial line is longer than the distance from other inner walls of the slot to the central axial line.

6. The structure defined in claim 1, wherein the locating end of the clip is less wide than the locating wall.

7. The structure defined in claim 1, wherein an axial groove is opened on the locating wall for accommodating the clip.

8. The structure defined in claim 1, wherein a slot is grooved into either the front or rear end of the tool handle, and a clip is arranged within the slot.

9. The structure defined in claim 1, wherein a steel ball is embedded onto exterior of the inserting portion of the tool head.
